(19) United States
(12) Patent Application Publication
(10) Pub. No.: US 2018/0170230 A1
(43) Pub. Date: Jun. 21, 2018

(54) AIR SUPPLY DEVICE AND VEHICLE SEAT

(71) Applicant: Toyota Jidosha Kabushiki Kaisha, Toyota-shi (JP)

(72) Inventors: Masahiko ONUMA, Toyota-shi (JP); Yuuki KADONO, Toyota-shi (JP)

(73) Assignee: TOYOTA JIDOSHA KABUSHIKI KAISHA, Toyota-shi (JP)

(21) Appl. No.: 15/843,418

(22) Filed: Dec. 15, 2017

(30) Foreign Application Priority Data
Dec. 21, 2016 (JP) 2016-248293

(51) Int. Cl. B60N 2/90; B60N 2/02

(52) U.S. Cl. CPC B60N 2/914; B60N 2002/026; B60N 2/0244

(57) ABSTRACT

Provided is an air supply device including a tubular member, a pump head, and a movable body. The pump head includes an air intake portion through which air flow into the tubular member and an air delivery portion through which the air flown into the tubular member is delivered to an airbag disposed in at least a seat back in a vehicle seat. The movable body is configured such that the tubular member is expanded and contracted, the air is flown into the tubular member from the air intake portion, and the air flown into the tubular member is delivered from the air delivery portion as a result of a reciprocating movement resulting from energization of a coil portion, the movable body approaching and moving away from the pump head during the reciprocating movement.

### INCORPORATION BY REFERENCE

The disclosure of Japanese Patent Application No. 2016-248293 filed on Dec. 21, 2016 including the specification, drawings and abstract is incorporated herein by reference in its entirety.

### BACKGROUND

### 1. Technical Field

The disclosure relates to an air supply device and a vehicle seat provided with an air supply device.

### 2. Description of Related Art

In general, a rolling-type pump is used as an air supply device supplying air to an airbag. The rolling-type pump is a structure in which a piston is moved up and down by becoming eccentric with respect to a motor shaft, and thus the vibration and noise of the rolling-type pump are hardly reduced. Accordingly, in a case where the pump is disposed in a seat back of a vehicle seat, the pump is disposed with a vibration-proof member interposed, which is known in the related art (refer to, for example, Japanese Unexamined Patent Application Publication No. 2009-225843 (JP 2009-225843 A)).

### SUMMARY

An increase in the number of components and an increase in manufacturing cost result from the structure in which the pump (air supply device) is disposed with the vibration-proof member interposed. Accordingly, the vibration and noise of the pump need to be reduced so that the pump is disposed in the vehicle seat without the interposed vibration-proof member.

The disclosure provides an air supply device capable of reducing vibration and noise and a vehicle seat provided with an air supply device.

A first aspect of the disclosure relates to an air supply device including a tubular member expandable and contractible in an axial direction of the tubular member, a pump head attached to a first end portion of the tubular member in the axial direction, one of a permanent magnet and a coil portion being disposed on the pump head; and a movable body attached to a second end portion of the tubular member in the axial direction, the other one of the permanent magnet and the coil portion being disposed on the movable body. The pump head includes an air intake portion through which air flow into the tubular member and an air delivery portion through which the air flown into the tubular member is delivered to an airbag disposed in at least a seat back in a vehicle seat. The movable body is configured such that the tubular member is expanded and contracted, the air is flown into the tubular member from the air intake portion, and the air flown into the tubular member is delivered from the air delivery portion as a result of a reciprocating movement of the movable body resulting from energization of the coil portion, the movable body approaching the pump head and moving away from the pump head during the reciprocating movement.

According to the first aspect of the disclosure, a so-called voice coil motor-type based on the permanent magnet and the coil portion is means for allowing the movable body attached to the second end portion of the tubular member in the axial direction to perform the reciprocating movement with respect to the pump head attached to the first end portion of the tubular member in the axial direction in which the tubular member is expandable and contractible. Accordingly, vibration and noise can be reduced compared to a rolling-type air supply device.

A second aspect of the disclosure relates to an air supply device including a tubular member expandable and contractible in an axial direction of the tubular member, a pump head attached to a first end portion of the tubular member in the axial direction, a first end portion of a member made of an elongated shape memory alloy being disposed in the pump head and the member being contracted in an energized state and being restored in a non-energized state, and a movable body attached to a second end portion of the tubular member in the axial direction, a second end portion of the shape memory alloy member being disposed in the movable body. The pump head includes an air intake portion through which air flow into the tubular member and an air delivery portion through which the air flown into the tubular member is delivered to an airbag disposed in at least a seat back in a vehicle seat. The movable body is configured such that the tubular member is expanded and contracted, the air is flown into the tubular member from the air intake portion, and the air flown into the tubular member is delivered from the air delivery portion as a result of a reciprocating movement of the movable body resulting from energization and non-energization of the shape memory alloy member, the movable body approaching the pump head and moving away from the pump head during the reciprocating movement.

According to the second aspect of the disclosure, the member made of the elongated shape memory alloy, contracted in the energized state, and restored in the non-energized state is means for allowing the movable body attached to the second end portion of the tubular member in the axial direction of the tubular member to reciprocate with respect to the pump head attached to the first end portion of the tubular member in the axial direction in which the tubular member is expandable and contractible. Accordingly, vibration and noise can be reduced compared to a rolling-type air supply device.

A third aspect of the disclosure relates to a vehicle seat including the air supply device disposed in a seat cushion or a seat back and a plurality of airbags disposed in at least the seat back and pressing a seated occupant's body part by being expanded by air delivered from the air delivery portion.

According to the third aspect of the disclosure, the vehicle seat provided with the air supply device can be obtained without an interposed vibration-proof member (without an increase in the number of components) with the vibration and noise of the air supply device reduced compared to a rolling-type air supply device.

The vehicle seat according to the third aspect of the disclosure may further include an air supply and exhaust device disposed in the seat cushion or the seat back, disposed downstream of the air delivery portion in an air delivery direction the air is delivered from the air delivery portion, disposed upstream of the airbags in the air delivery direction, and performing air supply to the airbags and air discharge from the airbags independently and an electronic control unit disposed in the seat cushion or the seat back and configured to control the operation of the air supply device and timings of the air supply and exhaust for each of the airbags performed by the air supply and exhaust device.

According to the third aspect of the disclosure, the air supply and exhaust device is controlled by the electronic control unit such that a relaxing effect and an arousal effect can be provided for the occupant seated in the vehicle seat. The relaxing effect is based on an acupressure mode in which the airbag is expanded and contracted at, for example, 1 Hz. The arousal effect is based on a vibration mode in which the airbag is expanded and contracted at, for example, 150 Hz.

According to the first and second aspects of the disclosure, the vibration and noise of the air supply device can be reduced.

According to the third aspect of the disclosure, the vehicle seat provided with the air supply device in which the vibration and noise are further reduced can be obtained.

According to the third aspect of the disclosure, the relaxing effect and the arousal effect can be provided for the occupant seated in the vehicle seat.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view illustrating a vehicle seat in which an air supply device and an airbag according to the present disclosure are disposed;

FIG. 2 is a side sectional view illustrating a vehicle seat in which an air supply device and an airbag according to a first embodiment are disposed;

FIG. 3 is a sectional view illustrating the air supply device, an air supply and exhaust device (electronic control unit), and the airbag according to the first embodiment;

FIG. 4 is a sectional view illustrating an air supply device, an air supply and exhaust device (electronic control unit), and an airbag according to a second embodiment; and

FIG. 5 is a front view illustrating a movable body of the air supply device according to the second embodiment.

### DETAILED DESCRIPTION OF EMBODIMENTS

Hereinafter, embodiments of the disclosure will be described in detail with reference to accompanying drawings. The arrows UP, FR, and RH that are appropriately shown in each of the drawings for convenience of description represent the directions toward the top, the front, and the right side of a vehicle seat 10, respectively. Accordingly, the up-down, front-rear, and right-left directions mentioned in the following description respectively represent the up-down direction, the front-rear direction, and the right-left direction of the vehicle seat 10 (width direction of the seat) unless otherwise noted.

In the following description, the surface of the vehicle seat 10 according to the present disclosure that supports an occupant (surface on which an occupant is seated) will be referred to as a “surface” and the surface of the vehicle seat 10 according to the present disclosure that is on the side opposite to the surface will be referred to as a “back surface”. Likewise, the surface side on which the occupant is seated will be referred to as a “surface” side and the surface side that is opposite to the surface side will be referred to as a “back surface” side regarding each of a seat pad 20 (described later), a plurality of airbags 30 (described later), and the rest of the components that constitute the vehicle seat 10.

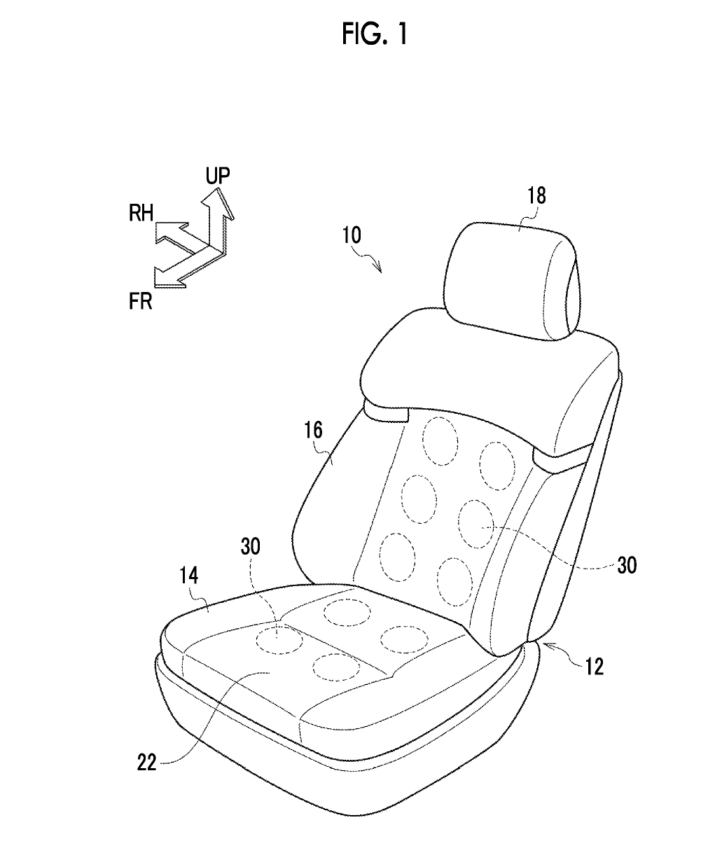

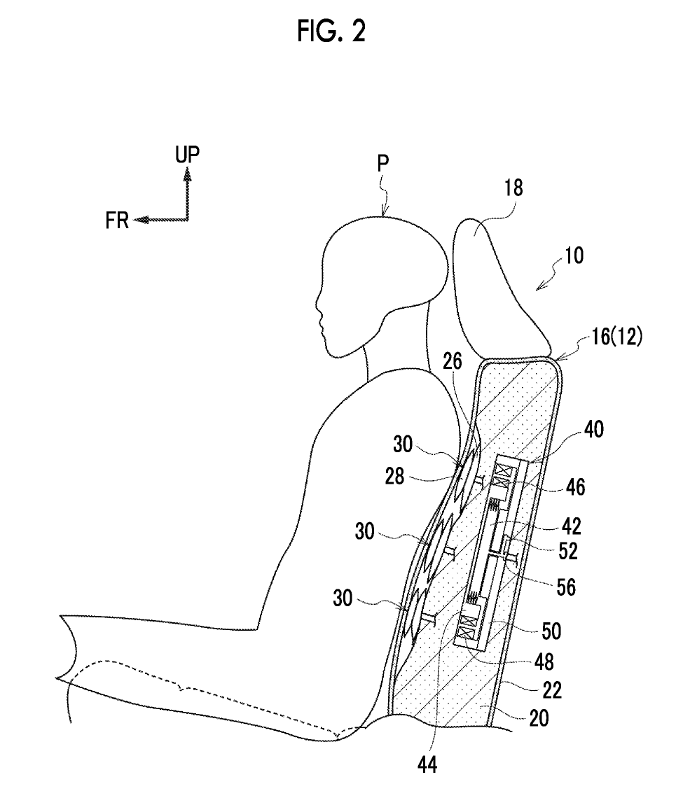

As illustrated in FIG. 1, the vehicle seat 10 is provided with a seat body 12 that includes a seat cushion 14 and a seat back 16. The seat cushion 14 supports the buttocks and the femoral region of a seated occupant P (refer to FIG. 2). The seat back 16 is disposed to extend upward from the rear end portion of the seat cushion 14 and supports the waist and the back of the occupant P. A headrest 18 is disposed in the upper end portion of the seat back 16. The headrest 18 supports the head of the occupant P.

As illustrated in FIG. 2, the seat back 16 has the seat pad 20 formed of a cushion body and a skin 22 covering the seat pad 20. A foamed resin such as foamed urethane constitutes the seat pad 20, and the seat pad 20 is configured for at least the skin 22 that is on the surface side to be capable of expanding forward with expansion of the airbags 30 (described later). The skin 22 constitutes the design surface of the vehicle seat 10.

The seat cushion 14 also has a seat pad (not illustrated) formed of a cushion body and the skin 22 covering the seat pad (refer to FIG. 1). As illustrated in FIG. 1, the airbags 30 for massaging (refreshing) are disposed in each of the seat cushion 14 and the seat back 16 constituting the seat body 12 of the vehicle seat 10.

Each of the airbags 30 is expanded by air being supplied and is contracted by air being discharged. Each of the airbags 30 massages body parts of the occupant P, such as his or her waist, back, or femoral region, by being expanded and pressing the body parts and relaxes (refreshes) the occupant P as a result.

The airbags 30 in the seat back 16 are disposed in, for example, two rows in the up-down direction (refer to FIG. 1). The airbags 30 in the seat cushion 14 are disposed in, for example, two rows in the front-rear direction (refer to FIG. 1). As the airbags 30 have the same configuration, the airbags 30 disposed in the seat back 16 will be mainly described below as an example.

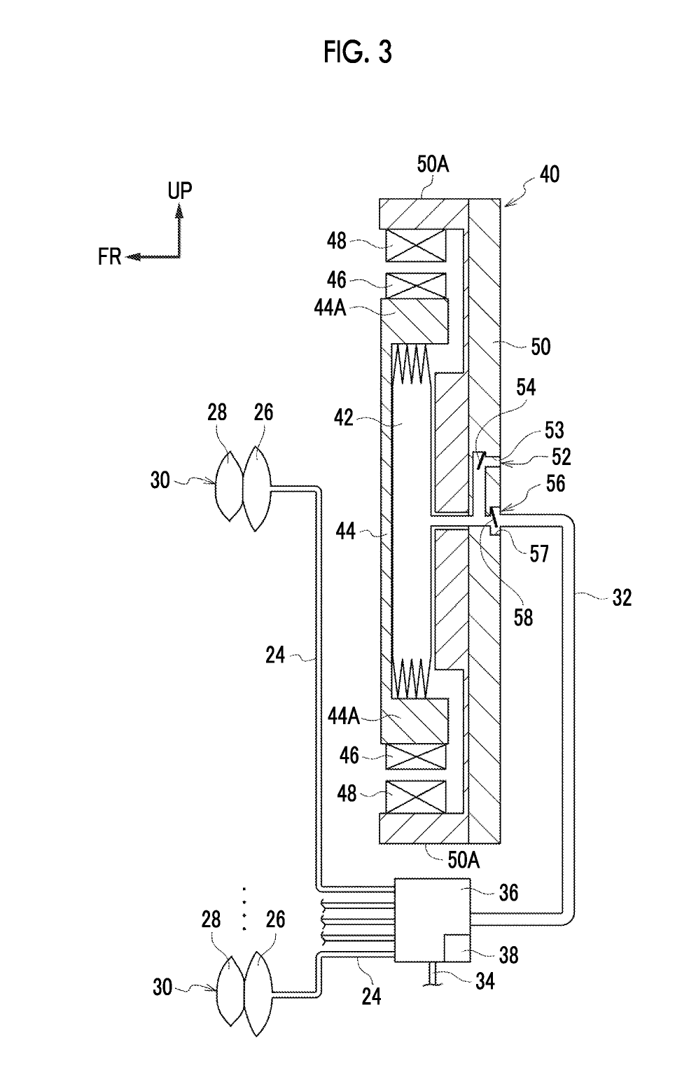

A resin material such as polyurethane and a material capable of expanding and contracting such as a rubber material constitute each of the airbags 30. As illustrated in FIG. 1, each of the airbags 30 is formed in a substantially circular shape in front view as seen from the front. As illustrated in FIGS. 2 and 3, each of the airbags 30 is configured to include a large bag portion 26 and a small bag portion 28. The small bag portion 28 is formed on the surface side of the large bag portion 26 and integrally with the large bag portion 26 such that air can be circulated.

The airbags 30 disposed in the seat back 16 are disposed between the seat pad 20 and the skin 22 by the back surfaces of the airbags 30 being fixed to the surface of the seat pad 20 by a double-sided tape and an adhesive. In other words, the airbags 30 disposed in the seat back 16 are disposed in a state where the back surfaces of the large bag portions 26 are fixed to the surface of the seat pad 20 and the surfaces of the small bag portions 28 are in contact with the back surface of the skin 22 (refer to FIG. 2).

### First Embodiment

Hereinafter, an air supply device 40 and an air supply and exhaust device 36 (including an electronic control unit 38) according to a first embodiment, which perform air supply and discharge on each of the airbags 30 and expand and contract the airbags 30 in an individual manner, will be described with reference to FIGS. 2 and 3. The air supply device 40 and the air supply and exhaust device 36 (including the electronic control unit 38) are disposed in the seat back 16 (or in the seat cushion 14).

As illustrated in FIGS. 2 and 3, the air supply device 40 is provided with a tubular member 42, a pump head 50, and a movable body 44. The tubular member 42 is formed in a bellows shape, is capable of expanding and contracting in its axial direction, and has a substantially rectangular shape in front view. The pump head 50 has a substantially rectangular shape in front view and is attached to a first end portion of the tubular member 42 in the axial direction to block the tubular member 42 with the exception of an air intake portion 52 (described later) and an air delivery portion 56 (described later). The movable body 44 has a substantially rectangular shape in front view and is attached to a second end portion of the tubular member 42 in the axial direction to block the tubular member 42.

Vertical wall portions 44A protruding to the pump head 50 side are formed integrally with the peripheral edge portions of the movable body 44 and are disposed outside the tubular member 42. Coil portions 46 configured to be capable of being energized are disposed on the outer surfaces of the vertical wall portions 44A. Vertical wall portions 50A protruding to the movable body 44 side are formed integrally with the peripheral edge portions of the pump head 50. Permanent magnets 48 are disposed on the inner surfaces of the vertical wall portions 50A and face the coil portions 46.

In other words, the movable body 44 and the pump head 50 constitute a voice coil motor, and the movable body 44 performs a reciprocating movement with respect to the pump head 50, by approaching the pump head 50 and moving away from the pump head 50, as a result of the energization of the coil portions 46. Then, the tubular member 42 expands and contracts, air is taken into the tubular member 42 from the air intake portion 52, and the air taken into the tubular member 42 is delivered from the air delivery portion 56.

The air intake portion 52 and the air delivery portion 56 are formed substantially in the middle of the pump head 50. The air intake portion 52 is for air to be taken into the tubular member 42. The air delivery portion 56 is to deliver the air taken into the tubular member 42 to the airbags 30. The air intake portion 52 has a communicating passage 53 communicating with the atmosphere. A check valve 54 is disposed in the communicating passage 53. The check valve 54 is opened when air is taken in.

The air delivery portion 56 has a communicating passage 57. A first end portion of a delivery tube 32 communicates with and is connected to the communicating passage 57. A check valve 58 is disposed in the communicating passage 57. The check valve 58 is opened when air is delivered. The air supply and exhaust device 36 communicates with and is connected to a second end portion of the delivery tube 32. The air supply and exhaust device 36 performs air supply to the airbags 30 and air discharge from the airbags 30 in an individual manner.

The air supply and exhaust device 36 is disposed downstream of the air delivery portion 56 in the direction of the air delivery and upstream of each of the airbags 30 in the direction of the air delivery. The air supply and exhaust device 36 has a plurality of electromagnetic valves (not illustrated) as control valves. Second end portions of branch tubes 24 communicate with and are connected to the respective electromagnetic valves with first end portions of the branch tubes 24 communicating with and connected to the respective airbags 30. A flexible tube constitutes each of the branch tubes 24 and the delivery tube 32.

Each of the electromagnetic valves is a three-way valve and has a supply port (not illustrated), an intake port (not illustrated), and an exhaust port (not illustrated). The second end portions of the branch tubes 24 communicate with and are connected to the respective supply ports. The second end portion of the delivery tube 32 communicates with and is connected to the intake ports. An exhaust tube 34, which is to discharge the air in the airbags 30 to the atmosphere, communicates with and is connected to the exhaust ports.

The exhaust tube 34 may or may not be a flexible tube. The electronic control unit (ECU) 38 is provided integrally with the air supply and exhaust device 36. The electronic control unit 38 controls the operation of the air supply device 40 (energization of the coil portions 46) and the timing of the air supply and exhaust for each of the airbags 30 performed by the air supply and exhaust device 36 (opening and closing of each of the ports of the electromagnetic valves).

The electronic control unit 38 is electrically connected to an operation unit (not illustrated) that is operated by the occupant P seated in the vehicle seat 10, and the positions of the expanded and contracted airbags 30, the timing of the expansion and contraction (predetermined time lag), and so on can be appropriately set by the occupant P. The air supply device 40 is operated by the occupant P operating the operation unit, and then the body parts of the occupant P are intermittently pressed by the airbags 30 being expanded and contracted in an individual manner.

Specifically, air is supplied into the airbag 30 by the air supply device 40 and the airbag 30 is expanded in a supply state where the branch tube 24 and the delivery tube 32 communicate with each other by the supply port and the intake port of the electromagnetic valve being open and the exhaust port of the electromagnetic valve being closed as a result of the control by the electronic control unit 38.

The air is automatically discharged from the airbag 30 and the airbag 30 is contracted in an exhaust state where the branch tube 24 and the exhaust tube 34 communicate with each other by the supply port and the exhaust port of the electromagnetic valve being open and the intake port of the electromagnetic valve being closed as a result of the control by the electronic control unit 38.

The airbags 30 disposed around the waist of the occupant P are capable of functioning as a lumbar support for the occupant P as well by, for example, remaining expanded at all times as a result of the control by the electronic control unit 38. The amount of the air that is supplied to each of the airbags 30 can be adjusted by the capacity of the tubular member 42 being appropriately changed in accordance with the number of the airbags 30 disposed in the seat body 12 (seat cushion 14 and seat back 16).

The action of the air supply device 40 and the vehicle seat 10 according to the first embodiment that are configured as described above will be described below.

The air supply device 40 and the air supply and exhaust device 36 (including the electronic control unit 38) illustrated in FIGS. 2 and 3 are operated by the occupant P seated in the vehicle seat 10 illustrated in FIG. 1 operating the operation unit. In other words, a massage operation (acupressure mode) is initiated for the occupant P. Normally (when no massage operation is performed), each of the airbags 30 is controlled by the electronic control unit 38 such that it remains contracted (such that the electromagnetic valve is in the exhaust state).

Once the massage operation is initiated, the movable body 44 initiates the reciprocating movement and approaches and moves away from the pump head 50 by the coil portion 46 being energized as a result of the control by the electronic control unit 38.

Then, air is taken into the tubular member 42 from the air intake portion 52 (communicating passage 53) of the pump head 50, and then the air taken into the tubular member 42 is delivered into the delivery tube 32 from the air delivery portion 56 (communicating passage 57) of the pump head 50.

Then, the air delivered into the delivery tube 32 is supplied to a predetermined one of the airbags 30 communicating with and connected to the electromagnetic valve via the branch tube 24 with the electromagnetic valve in the supply state where the exhaust port is closed and the supply port and the intake port are open as a result of the control by the electronic control unit 38 in the air supply and exhaust device 36. In other words, the predetermined airbag 30 is expanded, the skin 22 expands, and the predetermined airbag 30 presses, for example, the waist, back, or femoral region of the seated occupant P.

Then, the electromagnetic valve communicating with and connected to the predetermined airbag 30 via the branch tube 24 with the predetermined airbag 30 expanded by the air being supplied is put into the exhaust state where the intake port is closed and the supply port and the exhaust port are open as a result of the control by the electronic control unit 38, and the air in the predetermined airbag 30 is discharged from the exhaust tube 34. In other words, the predetermined airbag 30 is contracted, the skin 22 returns to its original state, and the pressing of, for example, the waist, back, or femoral region of the seated occupant P by the airbag 30 is released.

The expansion and contraction described above are repeatedly performed at a predetermined frequency (such as 1 Hz) for at least one of the airbags 30 as a result of the control by the electronic control unit 38. As a result, massage is performed on, for example, the waist, back, or femoral region of the occupant P seated in the vehicle seat 10 and a relaxing effect and a refreshing effect are provided for the occupant P.

The air supply device 40 is a so-called voice coil motor-type device, and thus its vibration and noise can be reduced compared to a rolling-type air supply device (not illustrated). Accordingly, a vibration-proof member or the like is not needed when the air supply device 40 is disposed in the seat body 12 (in the seat cushion 14 or in the seat back 16). Therefore, an increase in the number of components can be suppressed and an increase in manufacturing cost can be suppressed.

In a configuration alternative to the operation of the operation unit by the occupant P, the massage operation may be automatically initiated based on control by the electronic control unit 38 when the occupant P is detected to be in a state of tension as a result of sensing of the state of the occupant P during driving based on an in-vehicle camera (not illustrated) and a state detection device (not illustrated) such as a sensor sensing the biosignals of the occupant P (examples of the biosignals including his or her respiration rate and heart rate).

When it is detected that the occupant P is likely to fall asleep as a result of the sensing of the state of the occupant P during driving based on the in-vehicle camera and the state detection device, vibration may be provided for the occupant P likely to fall asleep (vibration mode may be initiated) by at least one of the airbags 30 being repeatedly expanded and contracted at a frequency of 150 Hz or so as a result of the control by the electronic control unit 38.

In other words, drowsy driving by the occupant P may be prevented by an arousal effect being provided for the occupant P (by the attention of the occupant P being drawn). When the airbags 30 are vibrated in a predetermined order and at predetermined time intervals during the drowsy driving prevention, the occupant P can predict to some extent which one of the airbags 30 is vibrated. Accordingly, the arousal effect can be effectively provided for the occupant P without discomfort.

When the airbags 30 are vibrated at random and at predetermined time intervals during the drowsy driving prevention, the occupant P cannot predict which one of the airbags 30 is vibrated. Accordingly, the occupant P becoming accustomed to the vibration of the airbag 30 at a fixed position can be prevented. Accordingly, the arousal effect can be provided for the occupant P even more effectively.

The supply port of the electromagnetic valve may remain open at all times in a state where the airbag 30 is expanded and the intake port and the exhaust port may be alternately opened and closed at a predetermined timing (such as every 0.2 seconds) with the air supply device 40 operated as a result of the control by the electronic control unit 38 for the vibration of the airbag 30. In addition, the supply port of the electromagnetic valve may remain closed and the vibration of the air supply device 40 itself may be transmitted to the occupant P via the seat back 16 or the like at this time.

The vibration mode described above also functions as a so-called vibrator, and thus the relaxing effect and the refreshing effect can be provided for the occupant P by massage based on the vibrator function being performed on, for example, the waist, back, or femoral region of the occupant P seated in the vehicle seat 10.

When the vibration for the occupant P can be provided by the airbag 30, no vibration generating device needs to be separately disposed in the vehicle seat 10. Accordingly, an increase in the number of components and an increase in manufacturing cost attributable to the disposition of a separate vibration generating device in the vehicle seat 10 can be suppressed or prevented.

### Second Embodiment

An air supply device 60 according to a second embodiment will be described below. The same reference numerals will be used to refer to the same parts as in the first embodiment, and detailed description thereof will be appropriately omitted along with the action that is common to the first and second embodiments.

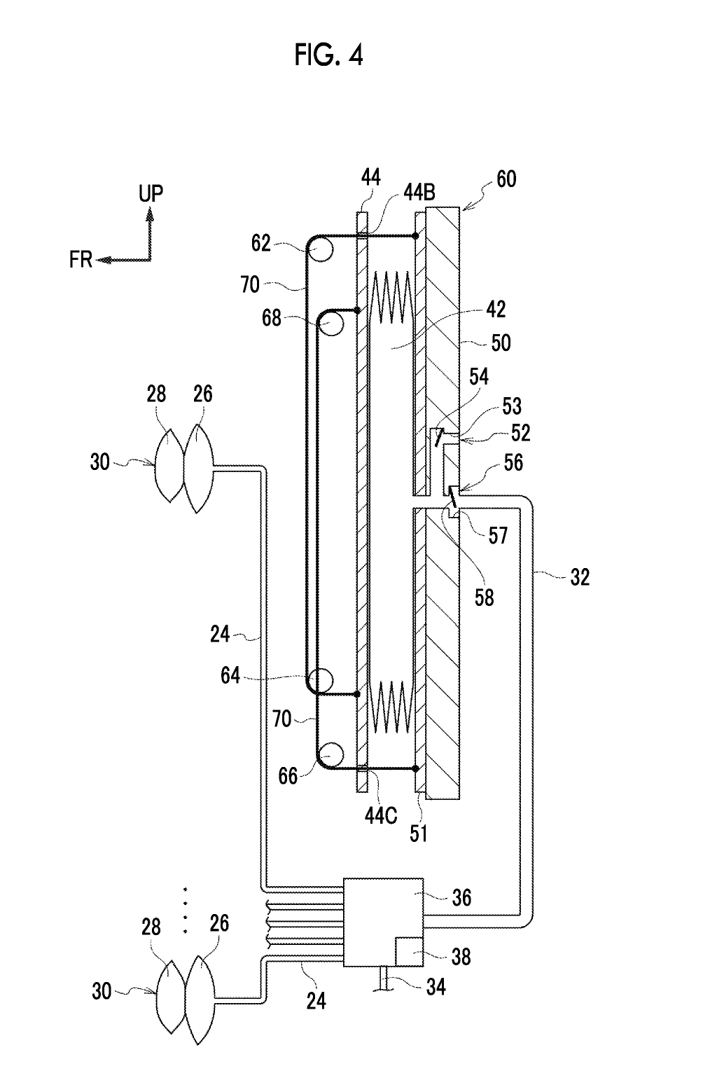

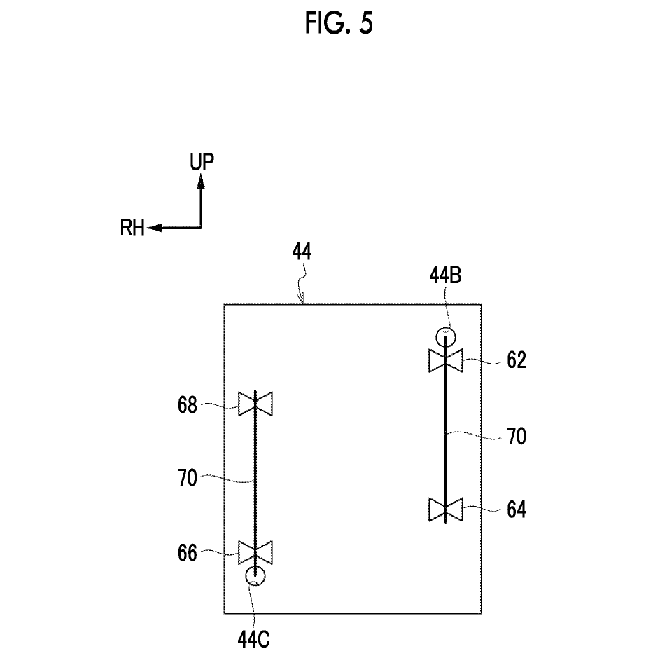

As illustrated in FIGS. 4 and 5, the air supply device 60 has two shape memory alloy wires (hereinafter, simply referred to as “wires”) 70 as members made of an elongated shape memory alloy that is contracted in an energized state and restored in a non-energized state. The air supply device 60 is configured for a tubular member 42 to be expanded and contracted by the wires 70 causing a movable body 44 to approach and move away from a pump head 50.

Specifically, pulleys 62, 64, 66, 68, which have the width direction of the seat as their axial direction, are disposed in the vicinity of the upper left corner portion, the lower left corner portion, the lower right corner portion, and the upper right corner portion of the front face of the movable body 44, respectively (refer to FIG. 5). In addition, through-holes 44B, 44C, into which the wires 70 can be inserted, are formed above the pulley 62 on the upper left side of the movable body 44 and below the pulley 66 on the lower right side of the movable body 44, respectively. An electronic substrate capable of energizing the wires 70 constitutes the movable body 44. In addition, an electronic substrate 51 capable of energizing the wires 70 is provided integrally with the front face of the pump head 50.

The upper end portion (first end portion) of the wire 70 wound around the pulley 62 on the upper left side and the pulley 64 on the lower left side with its lower end portion (second end portion) attached in the vicinity of the lower left corner portion of the front face of the movable body 44 is inserted into the through-hole 44B formed in the upper left corner portion of the movable body 44 and is attached to the upper left corner portion of the front face (electronic substrate 51) of the pump head 50.

Likewise, the lower end portion (first end portion) of the wire 70 wound around the pulley 66 on the lower right side and the pulley 68 on the upper right side with its upper end portion (second end portion) attached in the vicinity of the upper right corner portion of the front face of the movable body 44 is inserted into the through-hole 44C formed in the lower right corner portion of the movable body 44 and is attached to the lower right corner portion of the front face (electronic substrate 51) of the pump head 50.

Accordingly, the reciprocating movement during which the movable body 44 approaches and moves away from the pump head 50 is repeated and the tubular member 42 is expanded and contracted by the energization and non-energization of the wires 70 being repeated as a result of control by an electronic control unit 38. In other words, air is taken into the tubular member 42 from an air intake portion 52 of the pump head 50 and the air taken into the tubular member 42 is delivered from an air delivery portion 56 of the pump head 50.

The air supply device 40 and the vehicle seat 10 according to the first and second embodiments are not limited to the air supply device 40 and the vehicle seat 10 according to the first and second embodiments that have been described with reference to the accompanying drawings, and any appropriate change in design can be applied thereto without departing from the scope of the disclosure.

For example, the disposition of the electromagnetic valves is not limited to the disposition for each of the airbags 30 according to the configuration described above. Several airbags 30 may be connected to a single electromagnetic valve instead. In other words, several of the airbags 30 may be configured to be expanded and contracted at the same time.

The airbags 30 may be disposed in at least the seat back 16 and may not be disposed in the seat cushion 14. Although each of the pump head 50, the movable body 44, and the tubular member 42 is formed in a substantially rectangular shape in front view according to the configuration described above, their shapes are not limited thereto and each of the pump head 50, the movable body 44, and the tubular member 42 may also be formed in a substantially circular shape or the like in front view.

According to the configuration described above, the air supply device 40 and the air supply and exhaust device 36 (including the electronic control unit 38) are disposed in the seat cushion 14 or the seat back 16. However, the disclosure is not limited thereto and the air supply device 40 and the air supply and exhaust device 36 (including the electronic control unit 38) may also be disposed outside the seat cushion 14 or the seat back 16. For example, the air supply device 40 and the air supply and exhaust device 36 (including the electronic control unit 38) may be disposed on the lower surface of the seat cushion 14, on the rear face of the seat back 16, or in a lower portion of a floor panel (not illustrated) to which the vehicle seat 10 is attached.

The electronic control unit 38 is provided integrally with the air supply and exhaust device 36 according to the configuration described above. However, the disclosure is not limited thereto and the electronic control unit 38 may be disposed separately from the air supply and exhaust device 36 as well. In addition, the permanent magnet 48 may be disposed on the movable body 44 and the coil portion 46 may be disposed on the pump head 50 in the first embodiment. In the second embodiment, members made of a shape memory alloy are not limited to the wires 70 and may include, for example, one that is formed in a band shape.

What is claimed is:

1. An air supply device comprising:
a tubular member expandable and contractible in an axial direction of the tubular member
a pump head attached to a first end portion of the tubular member in the axial direction, one of a permanent magnet and a coil portion being disposed on the pump head; and
a movable body attached to a second end portion of the tubular member in the axial direction, the other one of the permanent magnet and the coil portion being disposed on the movable body,
the pump head including:
an air intake portion through which air flow into the tubular member; and
an air delivery portion through which the air flown into the tubular member is delivered to an airbag disposed in at least a seat back in a vehicle seat,
wherein the movable body is configured such that the tubular member is expanded and contracted, the air is flown into the tubular member from the air intake portion, and the air flown into the tubular member is delivered from the air delivery portion as a result of a reciprocating movement of the movable body resulting from energization of the coil portion, the movable body approaching the pump head and moving away from the pump head during the reciprocating movement.

2. A vehicle seat comprising:
the air supply device according to claim 1 disposed in a seat cushion or a seat back; and
a plurality of airbags disposed in at least the seat back and pressing a seated occupant's body part by being expanded by air delivered from the air delivery portion.

3. The vehicle seat according to claim 2, further comprising:
an air supply and exhaust device disposed in the seat cushion or the seat back, disposed downstream of the air delivery portion in an air delivery direction the air is delivered from the air delivery portion, disposed upstream of the airbags in the air delivery direction, and performing air supply to the airbags and air discharge from the airbags independently; and
an electronic control unit disposed in the seat cushion or the seat back and configured to control an operation of the air supply device and timings of the air supply and exhaust for each of the airbags performed by the air supply and exhaust device.

4. An air supply device comprising:
a tubular member expandable and contractible in an axial direction of the tubular member;
a pump head attached to a first end portion of the tubular member in the axial direction of the tubular member, a first end portion of a member made of an elongated shape memory alloy being disposed in the pump head and the member being contracted in an energized state and being restored in a non-energized state; and
a movable body attached to a second end portion of the tubular member in the axial direction of the tubular member, a second end portion of the elongated shape memory alloy member being disposed in the movable body,
the pump head including:
an air intake portion through which air flow into the tubular member; and
an air delivery portion through which the air flown into the tubular member is delivered to an airbag disposed in at least a seat back in a vehicle seat,
wherein the movable body is configured such that the tubular member is expanded and contracted, the air is flown into the tubular member from the air intake portion, and the air flown into the tubular member is delivered from the air delivery portion as a result of a reciprocating movement of the movable body resulting from energization and non-energization of the elongated shape memory alloy member, the movable body approaching the pump head and moving away from the pump head during the reciprocating movement.

5. A vehicle seat comprising:
the air supply device according to claim 4 disposed in a seat cushion or a seat back; and
a plurality of airbags disposed in at least the seat back and pressing a seated occupant's body part by being expanded by air delivered from the air delivery portion.

6. The vehicle seat according to claim 5, further comprising:
an air supply and exhaust device disposed in the seat cushion or the seat back, disposed downstream of the air delivery portion in an air delivery direction the air is delivered from the air delivery portion, disposed upstream of the airbags in the air delivery direction, and performing air supply to the airbags and air discharge from the airbags independently; and
an electronic control unit disposed in the seat cushion or the seat back and configured to control an operation of the air supply device and timings of the air supply and exhaust for each of the airbags performed by the air supply and exhaust device.
